(19) United States
(12) Patent Application Publication
(10) Pub. No.: US 2013/0011035 A1
(43) Pub. Date: Jan. 10, 2013

(54) IMAGING APPARATUS AND IMAGING METHOD

(75) Inventors: Tomohiko Shimoyama, Tokyo (JP); Takeshi Kitamura, Port Washington, NY (US); Kenji Muto, Fujisawa-shi (JP)

(73) Assignee: CANON KABUSHIKI KAISHA, Tokyo (JP)

(21) Appl. No.: 13/634,624

(22) PCT Filed: Mar. 29, 2011
(86) PCT No.: PCT/JP2011/001863

§ 371 Date: Sep. 13, 2012

(30) Foreign Application Priority Data
Mar. 31, 2010 (JP) 2010-082802

(51) Int. Cl. G06K 9/00

(52) U.S. Cl. 382/128

(57) ABSTRACT

An imaging apparatus according to the present invention is configured such that a plurality of measuring beams is directed within a predetermined length of time on overlapping regions or adjacent regions out of scanning areas of an eye to be examined corresponding to the plurality of measuring beams.

### TECHNICAL FIELD

The present invention relates to an imaging apparatus and an imaging method. More particularly, the present invention relates to an imaging apparatus configured to take an image of an object to be examined by using a plurality of measuring beams and an imaging method.

### BACKGROUND ART

Currently, there are known ophthalmic apparatuses using a confocal scanning laser ophthalmoscope (SLO) or optical coherence tomography (OCT) for obtaining a high-resolution tomographic image of an eye to be examined (pupil and fundus). The OCT apparatus is especially useful in diagnosing lesion of a retina such as degeneration of macula lutea.

In order to promptly acquire a three-dimensional structure of an ophthalmic interface, an OCT apparatus that can direct a plurality of low-coherent light beams onto a plurality points of a pupil is discussed in Patent Application Publication No. 2008-508068. However, scanning areas of an eye to be examined with a plurality of measuring beams are not discussed in Patent Application Publication No. 2008-508068.

Generally, a distorted image of an eye to be examined may be obtained due to an involuntary eye movement during fixation or blinking of the eye to be examined. In acquiring a single three-dimensional image by putting together three-dimensional images obtained using a plurality of measuring beams, if two images that are put together are captured before and after the involuntary eye movement or the blinking, similarity of such images will be decreased. Thus, putting together the images will take time or accuracy of the matching will be decreased.

### CITATION LIST

### Patent Literature

PTL 1: Patent Application Publication No. 2008-508068

### SUMMARY OF INVENTION

According to an aspect of the present invention, an imaging apparatus includes a scanning unit configured to scan with a first and a second measuring beams directed onto an eye to be examined and a control unit configured to control the scanning unit such that with the first and the second measuring beams directed onto an overlapping or adjacent regions out of a first and a second scanning areas of the eye to be examined onto which the first and the second measuring beams are directed, scanning is performed within a length of time the eye to be examined is making an involuntary eye movement during fixation in a distance equal to or less than a predetermined distance.

According to another aspect of the present invention, an imaging apparatus includes a first scanning unit configured to scan with a first measuring beam directed onto an object to be examined, a second scanning unit configured to scan with a second measuring beam directed onto the object to be examined, and a control unit configured to control the first and the second scanning units so that a sub-scanning of the first measuring beam and a sub-scanning of the second measuring beam are opposite in the directions.

As described above, the imaging apparatus according to the present invention is configured such that a plurality of measuring beams is directed onto overlapping or adjacent regions out of a plurality of scanning areas of an eye to be examined within a predetermined length of time. Since misregistration of the overlapping or the adjacent regions of the image due to involuntary eye movement during fixation or blinking is small, as the image is acquired by using the plurality of measuring beams, the similarity of the images is high. Thus, the images can be accurately put together in a short time.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1A illustrates an OCT apparatus according to a first exemplary embodiment of the present invention.

FIG. 1B illustrates an OCT apparatus according to a first exemplary embodiment of the present invention.

FIG. 1C illustrates an OCT apparatus according to a first exemplary embodiment of the present invention.

FIG. 2A illustrates first scanning

FIG. 2B illustrates first scanning

FIG. 3A illustrates scanning according to a second exemplary embodiment of the present invention.

FIG. 3B illustrates scanning according to a second exemplary embodiment of the present invention.

FIG. 4A illustrates scanning according to a third exemplary embodiment of the present invention.

FIG. 4B illustrates scanning according to a third exemplary embodiment of the present invention.

FIG. 5A illustrates scanning according to a fourth exemplary embodiment of the present invention.

FIG. 5B illustrates scanning according to a fourth exemplary embodiment of the present invention.

FIG. 6A illustrates search regions of a tomographic image in a case where similarity is high and where similarity is low.

FIG. 6B illustrates search regions of a tomographic image in a case where similarity is high and where similarity is low.

FIG. 7A illustrates imaging areas of the OCT apparatus according to the first exemplary embodiment.

FIG. 7B illustrates imaging areas of the OCT apparatus according to the first exemplary embodiment.

FIG. 7C illustrates imaging areas of the OCT apparatus according to the first exemplary embodiment.

### DESCRIPTION OF EMBODIMENTS

Various exemplary embodiments, features, and aspects of the invention will be described in detail below with reference to the drawings.

An OCT apparatus (imaging apparatus used for imaging an eye to be examined by using optical coherence tomography) according to the present embodiment is configured such that a plurality of measuring beams are directed within a predetermined length of time onto an overlapping or adjacent regions out of scanning areas of the eye to be examined corresponding to the plurality of measuring beams. The predetermined length of time is desirably a length of time the eye to be examined makes an involuntary eye movement equal or less than a predetermined distance. Thus, the overlapping or adjacent regions of the image acquired according to the plurality of measuring beams are image regions without misregistration caused by involuntary eye movement or blinking during fixation, so that they have high similarity. Thus, the images can be put together in a short time or with accuracy. The OCT apparatus according to the present embodiment desirably includes a scanning area setting unit configured to set each of a first and a second scanning areas of the eye to be examined corresponding to a first and a second measuring beams.

The imaging apparatus according to the present invention is not limited to an OCT apparatus, and an ophthalmic apparatus used for imaging an eye to be examined such as a SLO apparatus or an apparatus including functions of both OCT and SLO can also be used.

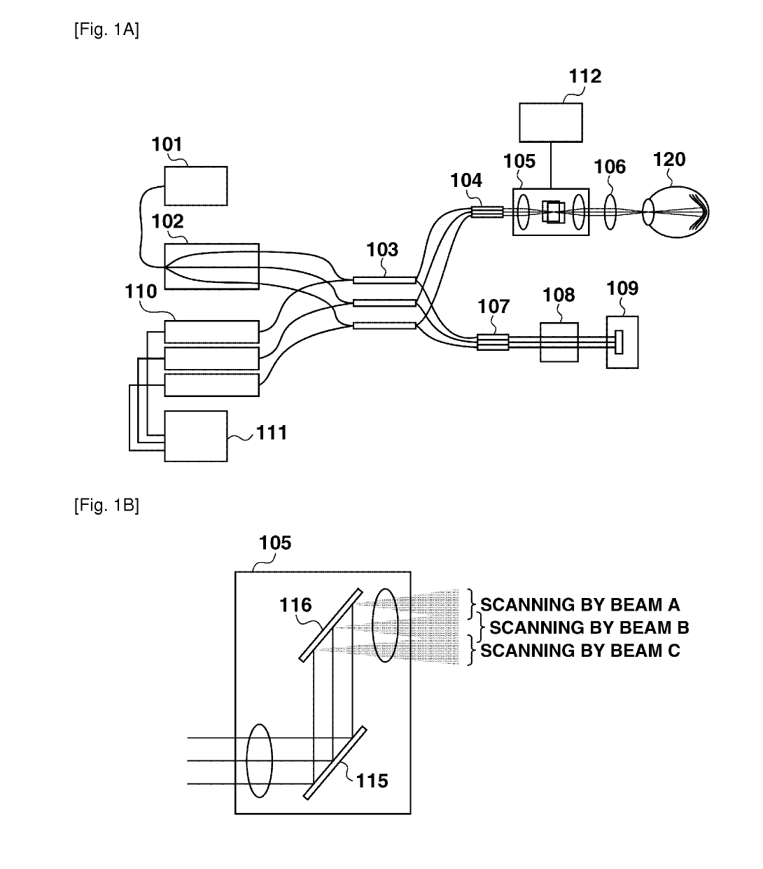

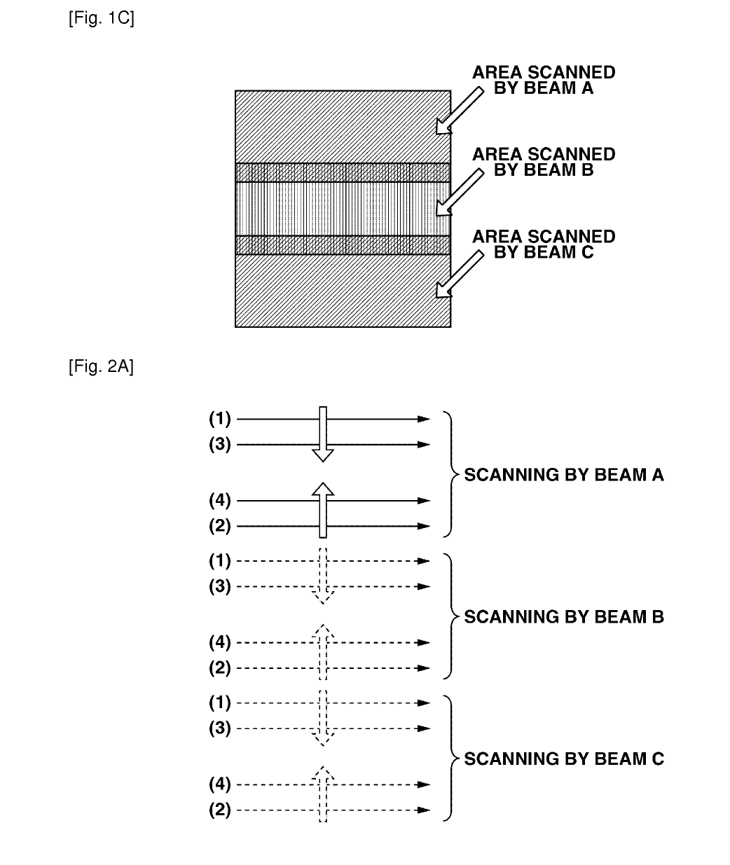

Overall configuration of the OCT apparatus according to the present embodiment will now be described with reference to FIG. 1. FIG. 1A illustrates a configuration of the OCT apparatus according to the present embodiment. Although a Michelson interferometer is illustrated in FIG. 1A, a Mach-Zehnder interferometer can also be used for the present embodiment.

The Michelson interferometer is a type of interferometer that allows shared use of a splitting unit and a recombining unit. The splitting unit splits a beam emitted from a light source into a measuring beam and a reference beam. The recombining unit recombines a return beam from an eye to be examined and the reference beam. The Mach-Zehnder interferometer is an interferometer that separately includes a splitting unit and a recombining unit. Although the Mach-Zehnder interferometer additionally requires components such as a beam splitter and a coupler compared to the Michelson interferometer, loss of light can be reduced.

First, a beam emitted from a light source 101 (also referred to as a low-coherent light source) is split into a plurality of light beams by a fiber beam splitter 102. A super luminescent diode (SLD) can be used as the light source 101. Further, beams of amplified spontaneous emission (ASE) or ultra-short pulse laser such as titaniumsapphire laser can be used for the light source 101.

Thus, the type of light source 101 is not limited so long as it can generate low-coherent light. Further, the wavelength of the light emitted from the light source 101 is not limited, but is normally in the range of 400 nm to 2 micrometers. Regarding the band of the wavelength, better longitudinal resolution can be obtained if the bandwidth is wide. Generally, if the center wavelength is 850 nm, resolution is 6 micrometers at a band of 50 nm and 3 micrometers at 100 nm, in air.

The light that is split into a plurality of beams is further split by a fiber coupler 103 (splitting unit) into a measuring beam and a reference beam. Further, the plurality of measuring beams (also referred to as a first beam and a second beam) are guided to an eye to be examined 120 via a fiber collimator 104, a scanning unit 105 (also referred to as a scanning optical unit), and an objective lens 106 (also referred to as an emission optical unit), which are arranged at a certain interval. Further, the OCT apparatus can include a control unit 112 that controls the scanning unit 105.

The scanning unit 105 scans a plurality of scanning areas (also referred to as a first and a second scanning area) of the eye to be examined 120 by using the plurality of measuring beams that are directed onto the eye to be examined 120. At this time, the scanning unit 105 performs the scanning so that the plurality of scanning areas overlaps each other or is adjacent to another. The measurement optical path is configured such that a plurality of measuring beams is directed within a predetermined length of time onto the above-described overlapping or adjacent regions.

Further, a plurality of reference beams is emitted from a fiber collimator 107 and guided to a reference mirror 109. A dispersion-compensating glass 108 can be provided on the reference optical path. The dispersion-compensating glass 108 is used for compensating wavelength dispersion of each reference beam. Further, although one reference mirror 109 is illustrated in FIG. 1, a mirror can be provided for each reference beam.

Further, a plurality of measuring beams is input to the fiber coupler 103 via the scanning unit 105 as return beams reflected or scattered by the eye to be examined 120. Further, a plurality of reference beams is reflected from the reference mirror 109 and input to the fiber coupler 103.

The plurality of return beams and the plurality of reference beams are recombined by the fiber coupler 103. Then, each of the recombined beam (also called as coherent light) is detected by a detection unit 110.

If the OCT apparatus employs spectral domain OCT (SD-OCT, post-dispersion), which is one type of Fourier domain OCT (FD-OCT), then the detection unit 110 (spectrometer) includes a dispersive element for dispersing the recombined light. The dispersive element is, for example, a diffraction grating or a prism. Further, the detection unit 110 includes a sensor used for detecting the beams dispersed by the dispersive element. The sensor is, for example, a line sensor or a two-dimensional sensor.

Further, if the OCT apparatus employs swept-source OCT (SS-OCT, pre-dispersion), being one type of FD-OCT, since the SS-OCT uses a light source that generates light beams of different wavelengths at a different time, recombined beams of such light beams are detected by a sensor such as a photodiode. At that time, the dispersive element is not necessary in acquiring the spectrum information. Further, if the OCT apparatus employs time domain OCT (TD-OCT), which is OCT different from FD-OCT, a sensor can be used for the detection unit 110, similar to the SS-OCT.

Further, each of the recombined light beams is transformed by Fourier transformation in a processing unit 111 using a wave number (inverse of wavelength). In this manner, a plurality of tomographic images of the eye to be examined 120 corresponding to each scanning area can be acquired. Then, tomographic images of the eye to be examined 120 corresponding to the overlapping or adjacent regions of the plurality of scanning areas are put together. When the plurality of measuring beams are irradiated, the beams are controlled such that they are emitted within a predetermined length of time with respect to the overlapping or adjacent regions.

In monitoring the imaging position of the eye to be examined in real time, it is desirable to prepare a retinal camera used for two-dimensional imaging of the eye to be examined in one operation using SLO or infrared light. Further, it is desirable to arrange the fixation target (also referred to as a fixation lamp) on the optical axis. This is because when the subject is asked to stare at the fixation target when the scanning of the fundus of the subject by the measuring beam is performed, the macula lutea, which is one of the important regions in the diagnosis, can be set at the center of the scanning area. If the measurement is performed without moving the scanning unit 105 by using the OCT apparatus described above, data of one line of A scan is obtained.

If the inside of the scanning unit 105 is continuously moved for the amount corresponding to the amount of resolution in the X direction each time one A scan ends, then an image of B scan is obtained. Similarly, if scanning in the Y direction is performed each time one B scan ends, a three-dimensional image of the retina can be obtained. The B scan images obtained by the scanning performed using each measuring beam are aligned by the processing unit 111 according to publicly-known template matching processing and then synthesized. As a result, one three-dimensional tomographic image is obtained.

Regarding the OCT apparatus of the present embodiment, a plurality of measuring beams scan the scanning area from the upper side and the lower side of the scanning area toward approximately the center of the area. The main scanning of the upper side and the main scanning of the lower side are generally performed alternately. According to the present embodiment, the scanning area is divided into three scanning areas in the approximately vertical direction with respect to the main scanning direction and scanned by the three measuring beams. A three-dimensional tomographic image of the object to be examined is acquired by using the three measuring beams.

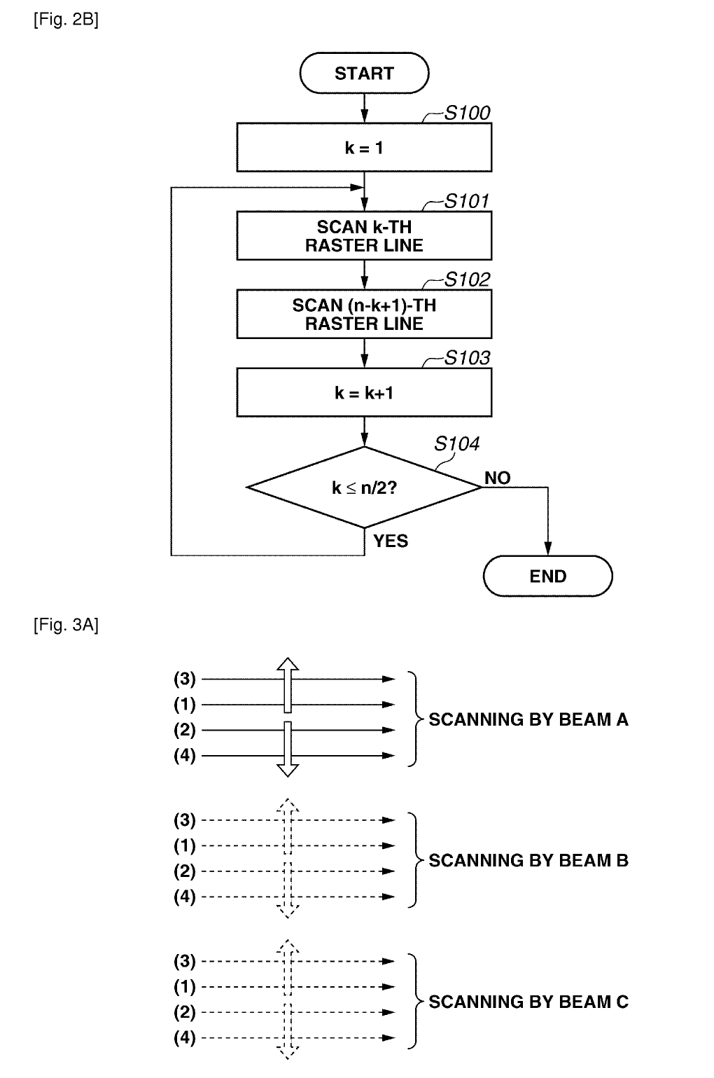

One measuring beam performs raster scanning of n lines in the assigned scanning area. As illustrated in FIG. 2A, the scanning is performed from the upper side and the lower side toward the center starting from the first raster line, the n-th raster line, the second raster line, and the (n−1)-th raster line. The OCT apparatus according to the present embodiment performs scanning of the scanning areas corresponding to the three measuring beams by using the three measuring beams in a similar manner, and at the same time.

Regarding an imaging apparatus that images an object to be examined by using a plurality of measuring beams, when the scanning is performed using the measuring beams, the scanning area can be uniformly raster-scanned from the top to the bottom of the scanning area. At that time, the tomographic images of the adjacent regions or the overlapping regions of the scanning area of the measuring beam A and the scanning area of the measuring beam B are acquired at the start time and the end time of the imaging.

When an image of an eye to be examined is captured by an OCT apparatus, movement of the eye to be examined may occur during the imaging due to, for example, involuntary eye movement. Thus, there is a high probability that the similarity of the tomographic image acquired from the above-described adjacent or overlapping regions is low. If the similarity is low, longer processing time will be necessary in matching the tomographic images. For example, regarding searching of matching points of tomographic images, a portion of one tomographic image is used as a template. Then the template is moved in various directions on another tomographic image to acquire the point having the highest similarity.

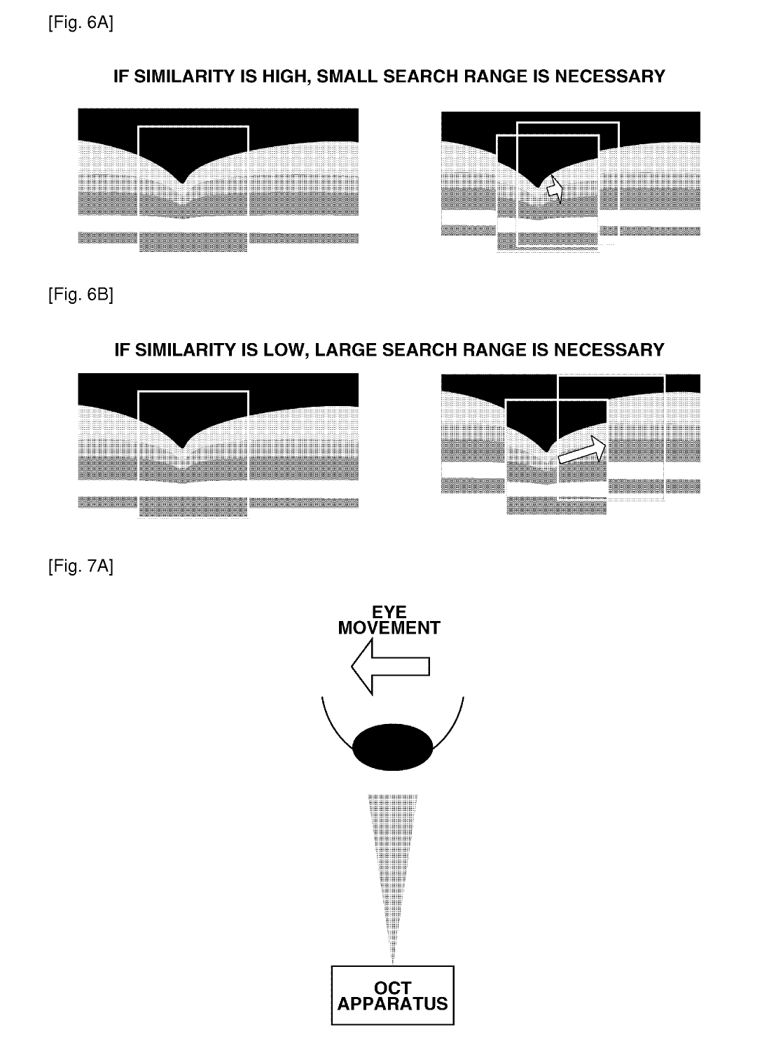

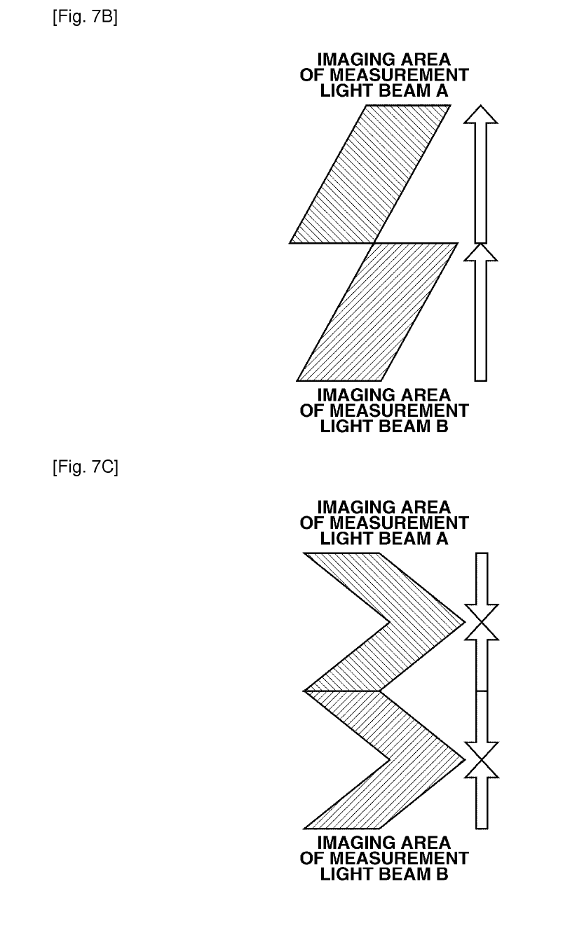

If the imaging of the above-described adjacent or overlapping regions is performed at close timing and the similarity of the tomographic images is high, the acquired tomographic images will be as illustrated in FIG. 6A. In this case, since a large search range of the template is not necessary, the above-described matching time can be reduced. On the other hand, if the timing of the above-described imaging is not close and a similar image cannot be rendered, since a large search range of the template will be necessary as illustrated in FIG. 6B, the amount of calculation necessary in the search (square order of the search range) will be increased, and longer search time will be consumed.

Although a case where the scanning areas are adjacent to each other or overlapping in the sub-scanning direction is described above, even when the scanning areas are adjacent to each other or overlapping in the main scanning direction, if the imaging timing is greatly different, misregistration of the images captured by each measuring beam will be increased. Thus, the processing necessary in matching the images becomes difficult to perform.

According to the present embodiment, the main scanning of each of the adjacent or overlapping regions is performed by using different measuring beams within a predetermined length of time (length of time the involuntary eye movement is made in a predetermined distance). Since the images acquired by using each measuring beam show little misregistration, image matching can be easily performed.

Next, control of the scanning unit (scanning optical system) 105 of the present exemplary embodiment will be described with reference to FIGS. 1B and 1C. As illustrated in FIG. 1B, the scanning unit 105 includes an X-axis mirror 115 and a Y-axis mirror 116. The X-axis mirror 115 is used for scanning a fundus by the measuring beam in the X direction. The Y-axis mirror 116 is used for scanning the fundus in the Y direction. Although the fundus is scanned by a plurality of measuring beams directed from one scanning unit 105, the fundus can be scanned by measuring beams directed from different scanning units according to the present invention.

The plurality of measuring beams are used for the scanning of different areas of the fundus divided in the sub-scanning direction. As illustrated in FIG. 1C, the scanning unit 105 can be controlled so that a portion of each scanning area overlaps another portion. Since the measuring beams that are used for the main-scanning of the overlapping regions are irradiated within a short length of time, the image matching of the images captured by each measuring beam can be easily performed.

The X-axis mirror 115 and the Y-axis mirror 116 are controlled by the control unit 112. The control unit 112 includes a calculation unit and controls the scanning unit according to a control program for controlling the X-axis mirror 115 and the Y-axis mirror 116.

Next, processing of the control program of the control unit 112 will be described with reference to the flowchart illustrated in FIG. 2B. In FIG. 2B, “n” indicates a total number of raster lines for one measuring beam. According to the description below, an even number is assigned to “n” so that the description can be simplified.

In step S100, the control unit 112 transmits a command to initialize a variable k to 1. In step S101, the control unit 112 transmits a command to the scanning unit 105 so that main scanning of the k-th line from the top of the scanning area is executed. This corresponds to sequentially executing the main scanning from the top of the scanning area toward the center. In step S102, the control unit 112 transmits a command to the scanning unit 105 so that main scanning of the (n−k+1)-th line is executed. This corresponds to sequentially executing the main scanning from the bottom of the scanning area toward the center.

In step S103, the control unit 112 transmits a command to increase k by 1. In step S104, the control unit 112 determines whether k is equal to or smaller than (n/2). If k is greater than (n/2) (NO in step S104), the processing ends. If k is equal to or smaller than (n/2) (YES in step 104), the processing returns to step S101, and the scanning is continued. According to this procedure, each scanning area is sequentially scanned from the top or the bottom of the area toward the center by each measuring beam.

Although the OCT apparatus according to the present embodiment uses three beams in the scanning, an arbitrary number of measuring beams can be used for the OCT apparatus. Further, although an overlapping portion is provided in each area scanned by the measuring beam according to the present embodiment, each area may be adjacent to another without overlapping. Since the scanning is performed by each measuring beam as described above, the boundary portion of the scanning areas scanned by each measuring beam can be scanned at close timing by each measuring beam. As a result, image matching necessary in acquiring the three-dimensional image can be performed more easily.

Further, according to the present embodiment, in order to facilitate the image matching, an overlapping portion is provided in each area scanned by the measuring beam. Since the image matching can be performed more easily according to the present invention, the overlapping portion of the scanning area can be reduced compared to the conventional scanning area. As a result, scanning time can be reduced.

Regarding the OCT apparatus according to a second exemplary embodiment, a plurality of measuring beams scan the scanning areas from approximately the center of each of the scanning areas toward the upper side and the lower side. The main scanning of the upper side and the main scanning of the lower side are generally performed alternately. Here, a control program of the control unit 112, which is different from the first exemplary embodiment, will be described.

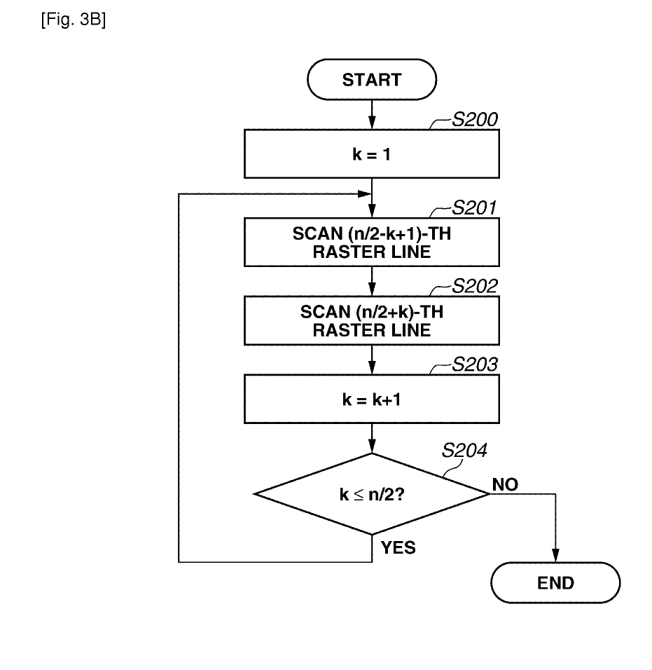

One measuring beam performs raster scanning of n lines in the assigned scanning area. As illustrated in FIG. 3A, the scanning is performed from the center to the top and the bottom starting such as scanning the (n/2)-th raster line, the (n/2+1)-th raster line, the (n/2-1)-th raster line, and the (n/2+2)-th raster line.

Next, processing of the control program of the control unit 112 will be described with reference to the flowchart illustrated in FIG. 3B. In FIG. 3B, “n” indicates a total number of raster lines for one measuring beam. According to the description below, an even number is assigned to “n” so that the description can be simplified.

In step S200, the control unit 112 initializes an internal variable k to 1. In step S201, the control unit 112 transmits a command to the scanning unit 105 so that the scanning of the (n/2−k+1)-th raster is executed. This corresponds to executing the scanning from the center of the scanning area toward the top of the area.

In step S202, the control unit 112 transmits a command to the scanning unit 105 so that scanning of the (n/2+k)-th raster is executed. This corresponds to executing the scanning from the center of the scanning area toward the bottom of the area. In step S203, the control unit 112 increases k by 1. In step S204, the control unit 112 determines whether k is equal to or smaller than (n/2). If k is greater than (n/2) (NO in step S204), the processing ends. If k is equal to or smaller than (n/2) (YES in step 204), the processing returns to step S201, and the scanning is continued.

According to the above-described procedure, each scanning area is sequentially scanned from the center toward the top or the bottom of the area by each measuring beam. Since the scanning is performed by each measuring beam as described above, the boundary portion of the scanning areas scanned by each measuring beam is scanned at close timing by each measuring beam. As a result, image matching necessary in acquiring the three-dimensional image can be performed more easily and the user can obtain a good matching image.

Regarding the OCT apparatus according to a third embodiment, a plurality of measuring beams scans the scanning areas from the upper side and the lower side of each of the scanning area toward the center in a spiral manner. Here, the description is focused on a control program of the control unit 112, which is different from the first exemplary embodiment.

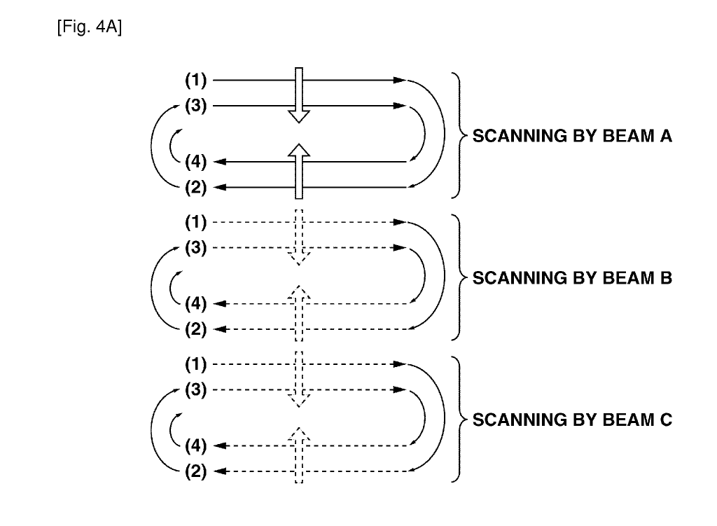

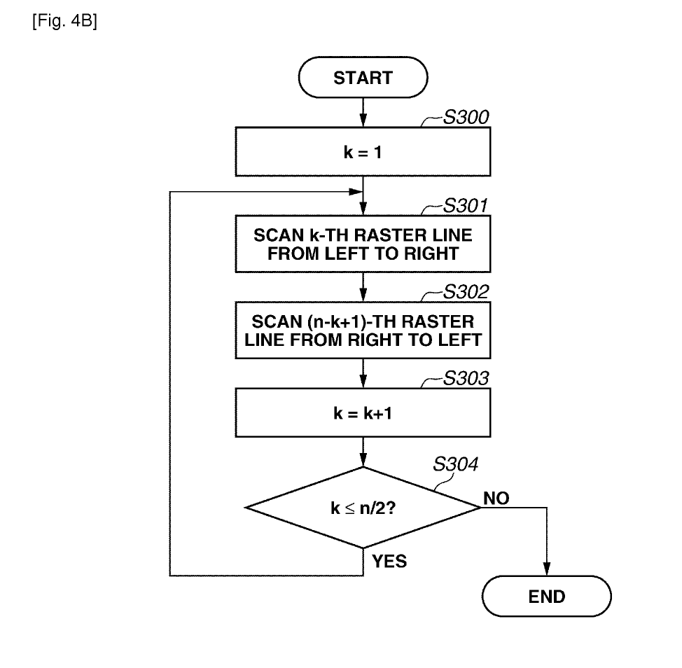

One measuring beam performs raster scanning of n lines in the assigned scanning area. As illustrated in FIG. 4A, the scanning is performed in a spiral manner from the top and the bottom toward the center such as scanning the first raster from left to right, the n-th raster from right to left, the second raster from left to right, and the (n−1)-th raster from right to left. In spirally scanning, the motion of the X-axis mirror can be reduced compared to the first exemplary embodiment. Thus, the scanning speed can be increased depending on the operation characteristics of the X-axis mirror.

Next, processing of the control program of the control unit 112 will be described with reference to the flowchart illustrated in FIG. 4B. In FIG. 4B, “n” indicates a total number of raster lines for one measuring beam. According to the description below, an even number is assigned to “n” so that the description can be simplified.

In step S300, the control unit 112 initializes the internal variable k to 1. In step S301, the control unit 112 transmits a command to the scanning unit 105 so that the scanning is performed from left to right. This corresponds to sequentially executing the scanning from the upper side of the scanning area toward the center.

In step S302, the control unit 112 transmits a command to the scanning unit 105 so that the scanning of the (n-k+1)-th raster from the right to left is executed. This corresponds to sequentially executing the scanning from the bottom toward the center of the area. In step S303, the control unit 112 increases k by 1. In step S304, the control unit 112 determines whether k is equal to or smaller than (n/2). If k is greater than (n/2) (NO in step S304), the processing ends. If k is equal to or smaller than (n/2) (YES in step 304), the processing returns to step S301, and the scanning is continued.

According to the above-described procedure, each scanning area is sequentially scanned in a spiral manner from the top and the bottom of the area toward the center by each measuring beam. Since the scanning is performed by each measuring beam as described above, the boundary portion of the scanning areas scanned by each measuring beam can be scanned at close timing by each measuring beam. As a result, image matching necessary in acquiring the three-dimensional image can be performed more easily and the user can obtain a good matching image.

Although the scanning area is scanned in a spiral manner from the top and the bottom of the area toward the center according to the present embodiment, it is also possible to scan the area from the center toward the top and the bottom of the area in a spiral manner.

The OCT apparatus according to a fourth exemplary embodiment scans a first scanning area with a first measuring beam (measuring beam A) from the top to the bottom and scans a second scanning area with a second measuring beam (measuring beam B) from the bottom to the top according to an optical structure. Here, the description is focused on the scanning unit 105, which is a different from the first exemplary embodiment.

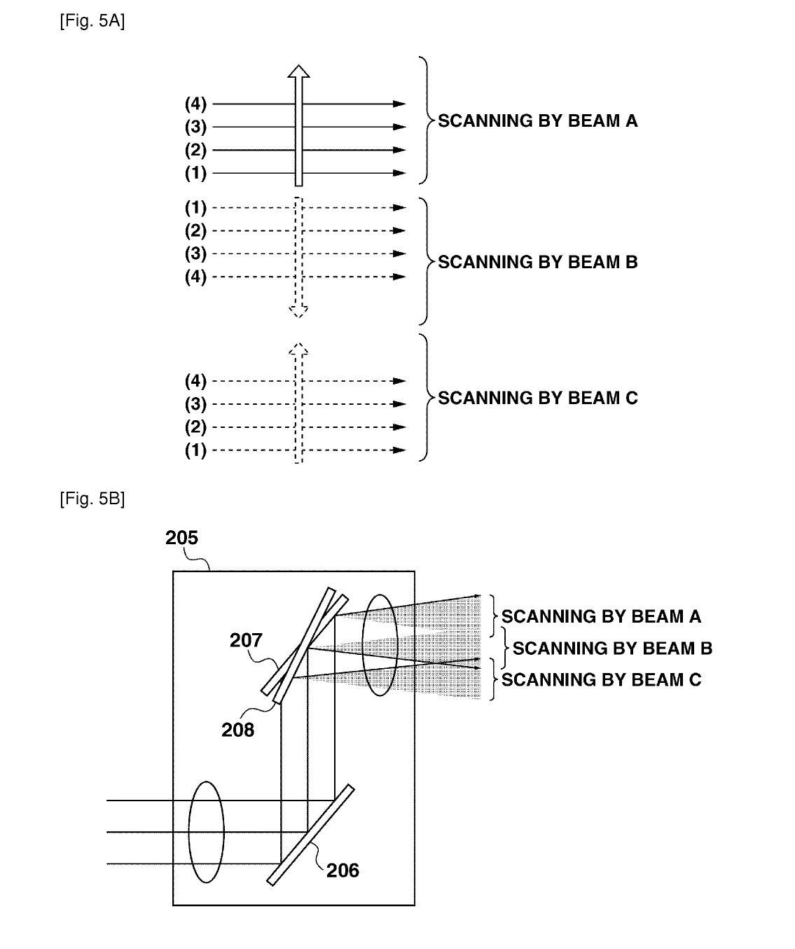

One measuring beam performs raster scanning of n lines in the assigned scanning area. As illustrated in FIG. 5A, the first raster line and the n-th raster line are simultaneously scanned by different measuring beams, and the second raster line and the (n−1)-th raster line are simultaneously scanned with different measuring beams. In other words, adjacent regions are scanned from opposite directions.

A scanning unit 205 according to the present embodiment is illustrated in FIG. 5B. The scanning unit 205 includes a first Y-axis mirror 207 (a first scanning unit) and a second Y-axis mirror 208 (a second scanning unit). The first and the second scanning units are controlled such that a scanning direction (also referred to as sub-scanning direction) of the first measuring beam reflected by the first Y-axis mirror 207 is opposite to a scanning direction of the second measuring beam reflected by the second Y-axis mirror 208.

Although three measuring beams are used in the present embodiment, the present invention is not limited to such number of measuring beams. For example, if the scanning is performed by assigning the measuring beam of an odd number to the first Y-axis mirror 207 and an even number to the second Y-axis mirror 208, an arbitrary number of measuring beams can be used in the present invention.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-082802 filed Mar. 31, 2010, which is hereby incorporated by reference herein in its entirety.

1. An imaging apparatus comprising:
a scanning unit configured to scan with a first and a second measuring beams directed onto an eye to be examined, and
a control unit configured to control the scanning unit such that with the first and the second measuring beams directed onto overlapping regions of parts of a first and a second scanning areas of the eye to be examined or adjacent regions out of the first and the second scanning areas of the eye to be examined onto which the first and the second measuring beams are directed, scanning is performed within a length of time the eye to be examined is making an involuntary eye movement during fixation in a distance equal to or less than a predetermined distance.

2. The imaging apparatus according to claim 1, wherein the first and the second scanning areas are aligned side by side in an approximately vertical direction with respect to a main scanning direction.

3. The imaging apparatus according to claim 1, wherein main scanning of lower sides of the first and the second scanning areas is performed after main scanning of upper sides of the first and the second scanning areas is performed, or main scanning of the upper sides is performed after main scanning of the lower sides is performed.

4. The imaging apparatus according to claim 1, wherein scanning is performed in such a manner that upper sides and lower sides of the first and the second scanning areas are scanned approximately alternately.

5. The imaging apparatus according to claim 1, wherein sub-scanning is performed in such a manner that the sub-scanning is performed from upper sides and lower sides of the first and the second scanning areas approximately toward the center or approximately from the center toward the upper sides and the lower sides.

6. The imaging apparatus according to claim 3, wherein a main scanning after sub-scanning and the main scanning before the sub-scanning are opposite in the directions.

7. The imaging apparatus according to claim 1, wherein the scanning unit includes a first scanning unit configured to scan with the first measuring beam and a second scanning unit configured to scan with the second measuring beam;
wherein the control unit controls the first and the second scanning units so that a sub-scanning of the first measuring beam in the first scanning area and a sub-scanning of the second measuring beam in the second scanning area are opposite in the directions.

8. An imaging method comprising:
determining each of a first and a second scanning area of an eye to be examined for scanning with a first and a second measuring beam, and
scanning a first and a second measuring beams directed onto overlapping regions of parts of the first and the second scanning areas or adjacent regions out of the first and the second scanning areas within a length of time the eye to be examined is making an involuntary eye movement during fixation within a distance equal to or less than a predetermined distance.

9. The imaging method according to claim 8, wherein the first and the second scanning areas are aligned side by side in an approximately vertical direction with respect to a main scanning direction.

10. A computer-executable program configured to cause a computer to execute the imaging method according to claim 8.

11. An imaging apparatus comprising:
a first scanning unit configured to scan with a first measuring beam directed onto an object to be examined;
a second scanning unit configured to scan with a second measuring beam directed onto the object to be examined; and
a control unit configured to control the first and the second scanning units so that a sub-scanning of the first measuring beam and a sub-scanning of the second measuring beam are opposite in the directions.
